(19) United States
(12) Patent Application Publication
(10) Pub. No.: US 2020/0131352 A1
(43) Pub. Date: Apr. 30, 2020

(54) THERMOPLASTIC COMPOSITE, METHOD OF MAKING THERMOPLASTIC COMPOSITE, AND INJECTION-MOLDED PRODUCT

(71) Applicant: 3M INNOVATIVE PROPERTIES COMPANY, St. Paul, MN (US)

(72) Inventors: Jingqiang Hou, Shanghai (CN); Stephen E. Amos, Minneapolis, MN (US)

(21) Appl. No.: 16/618,517

(22) PCT Filed: Jun. 2, 2017
(86) PCT No.: PCT/CN2017/086963

§ 371 Date: Dec. 2, 2019

(51) Int. Cl. C08L 23/12; C08J 3/20; B29C 45/00; B29C 44/10; B29C 48/00; B29B 9/06; B29B 9/14

(52) U.S. Cl. CPC C08L 23/12; C08J 3/201; B29C 45/0001; B29C 44/10; B29C 48/0022; B29C 48/022; B29K 2509/08; B29B 9/14; C08L 2205/025; C08L 2205/035; C08L 2205/16; C08L 2207/066; C08L 2201/08; B29B 9/06

(57) ABSTRACT

Provided is a thermoplastic composite, a method for preparing a thermoplastic composite, and an injection-molded product. The thermoplastic composite comprises 35% to 85% by weight of thermoplastic resin, 5% to 45% by weight of a non-cellulosic organic fiber, and hollow glass microspheres in an amount of less than 5% by weight, based on 100% by weight of the total weight of the thermoplastic composite.

### TECHNICAL FIELD

This disclosure relates to the field of thermoplastic composite preparation, and specifically, relates to a thermoplastic composite, a method for preparing thermoplastic composite, and an injection-molded product.

### SUMMARY

At present, in the field of the preparation of thermoplastic composites, there is a technical problem urgent to be solved that it is difficult to obtain a thermoplastic composite having all of low density, high modulus, and high toughness (defined herein as having high impact strength as measured by ASTM D256) at the same time after the thermoplastic resin is filled with high-strength hollow glass microspheres. Therefore, it is required to develop a novel thermoplastic composite having low density, high modulus, and high toughness, which is capable of being modified by hollow glass microspheres.

In order to address the problem described above, intensive and detailed studies have been performed by the inventor. An object of the present disclosure is to provide a method for preparing a composite using high-strength hollow glass microspheres and a non-cellulosic organic fiber to fill a thermoplastic resin, by which a thermoplastic composite with low density, high modulus, and high toughness can be prepared, and when a supercritical foaming technique is introduced into the injection molding process, the density of the composite may be further reduced while other mechanical properties of the material are maintained. This method is particularly suitable for the preparation and commercialization of light polyolefin composites.

According to an aspect, this disclosure provides a thermoplastic composite, comprising 35% to 85% by weight thermoplastic resin, 5% to 45% by weight of a non-cellulosic organic fiber, and hollow glass microspheres in an amount of less than 5% by weight, based on 100% by weight of the total weight of the thermoplastic composite.

According to another aspect, this disclosure provides a method for preparing such a thermoplastic composite. The method includes:

melt-mixing a thermoplastic resin and hollow glass microspheres to obtain a molten mixture; and

mixing and impregnating non-cellulosic organic fiber with the molten mixture to obtain a thermoplastic composite containing the thermoplastic resin, the hollow glass microspheres, and the non-cellulosic organic fiber.

According to a further aspect, this disclosure provides an injection-molded product including the thermoplastic composite described above which has been subjected to injection molding.

According to a further aspect, this disclosure provides an injection-molded product including the thermoplastic composite described above which has been subjected to supercritical foaming injection molding.

In some embodiments, technical solutions according to this disclosure have one or more of the advantages that (i) a thermoplastic composite with low density, high modulus, and high toughness can be prepared, and (ii) when a supercritical foaming technique is introduced into the injection molding process, the density of the composite may be further reduced while other mechanical properties of the material are substantially maintained.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

Various aspects and advantages of embodiments of the present disclosure have been summarized. The above Summary is not intended to describe each illustrated embodiment or every implementation of the present disclosure.

### BRIEF DESCRIPTION OF THE DRAWING

FIG. 1 is a schematic view showing an apparatus for performing a method of preparing a thermoplastic composite according to an embodiment of the present disclosure.

### DETAILED DESCRIPTION

The thermoplastic resin filled with high-strength hollow glass microspheres may improve the thermal shrinkage factor, enhance the rigidity of materials, reduce injection molding cycle times, and reduce the density of materials, and has begun to be applied to automobiles, for example. However, when the thermoplastic resin modified by high-strength hollow glass microspheres is used, mechanical properties (for example, impact strength, elongation at break, and tensile strength) of the thermoplastic resin would be typically reduced due to the introduction of high-strength hollow glass microspheres.

### Thermoplastic Composite

In one embodiment, thermoplastic composites described herein may comprise 35% to 85% by weight of a thermoplastic resin, 5% to 45% by weight of a non-cellulosic organic fiber, and hollow glass microspheres in an amount of less than 5% by weight, based on 100% by weight of the total weight of the thermoplastic composite.

The thermoplastic composite may employ a thermoplastic resin as the base material. For instance, the thermoplastic resin may be a thermoplastic resin selected from one or more of polypropylene, polyethylene, polyvinyl chloride, polystyrene, an ethylene-vinyl acetate copolymer (EVA), an acrylonitrile-styrene-butadiene copolymer (ABS), nylon 6, an ethylene propylene copolymer, an ethylene octene copolymer, an ethylene propylene diene copolymer, an ethylene propylene octene copolymer, polybutadiene, a butadiene copolymer, styrene/butadiene rubber (SBR), a block copolymer (e.g., styrene-isoprene-styrene or styrene-butadiene-styrene), or a styrene-ethylene-butylene-styrene triblock copolymer. Some of these copolymers are known as thermoplastic olefins (TPO) and thermoplastic elastomers (TPE). The molecular weight of the thermoplastic resin described above is not particularly limited as long as it is capable of satisfying the essential requirements for the preparation of thermoplastic materials. For instance, the thermoplastic resin may be polypropylene. Examples of useful ommercially available thermoplastic resins include PPK9026 and PPK8003 from Sinopec Limited, China; PP3800, PP3520 and PP3920 from SK Corporation, South Korea; PP3015 from Formosa Chemicals&Fibre Corporation, Taiwan; PPK2051 from Formosa Plastics Corporation, Taiwan. The content of the thermoplastic resin may, in some embodiments, be 35% to 85% by weight, 35% to 75% by weight, 40% to 70% by weight, or 48% to 70% by weight, based on 100% by weight of the total weight of the thermoplastic composite.

According to an embodiment of the present disclosure, a non-cellulosic organic fiber is added to the thermoplastic composite to increase, for example, the modulus and the toughness of the thermoplastic composite. According to some embodiments of the present disclosure, the non-cellulosic organic fiber is one or more selected from a nylon 66 fiber, a polyethylene terephthalate fiber, a polypropylene terephthalate fiber, a polyphenylene sulfide fiber, a polyether ether ketone fiber, and an aramid fiber. The non-cellulosic organic fiber may be further selected from other liquid crystal polymer fibers. In some embodiments, the non-cellulosic organic fiber is a nylon 66 fiber. The molecular weight of the non-cellulosic organic fiber described above is not particularly limited as long as it is capable of satisfying the essential requirements for the preparation of thermoplastic materials. According to some embodiments of the present disclosure, the non-cellulosic organic fiber may be several non-cellulosic organic fibers with a diameter of 5 μm to 70 μm, 8 μm to 50 μm, or 15 μm to 20 μm. Commercially available non-cellulosic organic fibers include PA (Nylon) 66 fiber T743 (from Invista China Co., Ltd.), which is a nylon 66 fiber with a diameter of 15 μm to 20 μm that has not been subjected to surface modification. According to some embodiments of the present disclosure, the content of the non-cellulosic organic fiber may be 5% to 45% by weight, 10% to 40% by weight, 15% to 35% by weight, or even 15% to 30% by weight, based on 100% by weight of the total weight of the thermoplastic composite.

According to some embodiments of the present disclosure, the higher melting peak (as measured in differential scanning calorimetry or DSC) of the non-cellulosic organic fiber should be 60° C. or more, 70° C. or more, or even 80° C. or more higher than that of the thermoplastic resin in order to achieve the object of the present disclosure for obtaining a thermoplastic composite with high modulus, high toughness, and low density.

The thermoplastic composite according of the present disclosure includes hollow glass microspheres. According to some embodiments of the present disclosure, hollow glass microspheres are added to the thermoplastic composite to decrease the density of the thermoplastic composite. In some embodiments, the hollow glass microspheres are in the thermoplastic composite in an amount of less than 5% by weight, based on the total weight of the thermoplastic composite. The hollow glass microspheres have an average particle diameter of 5 μm to 100 μm, 5 μm to 80 μm, or 10 μm to 50 μm. In addition, the hollow glass microspheres have a density of 0.3 g/cm³ to 0.8 g/cm³, 0.3 g/cm³ to 0.7 g/cm³, or 0.4 g/cm³ to 0.6 g/cm³. Furthermore, the hollow glass microspheres have a compressive strength greater than 37.9 MPa, in some embodiments greater than 48.3 MPa, in some embodiments greater than 55.2 MPa, or in some embodiments greater than 70.0 MPa. Commercially available hollow glass microspheres include those obtained under the trade designation “iM16K” from 3M Company, which has an average particle diameter of 20 μm, a density of 0.46 g/cm³, and a compressive strength of 113.8 MPa. According to some embodiments of the present disclosure, the content of the hollow glass microspheres is 0.1% to less than 5% by weight, 0.5% to 4.5% by weight, 0.5% to 4% by weight, 1% to 4.5% by weight, 1% to 4% by weight, or 1% to 3% by weight, based on 100% by weight of the total weight of the thermoplastic composite. As illustrated in the Examples below, when the thermoplastic composite comprises 15% to 30% by weight of non-cellulosic organic fiber and less than 5% by weight of hollow glass microspheres based on 100% by weight of the total weight of the thermoplastic composite, the toughness of the resultant thermoplastic composite is quite excellent, and a density of less than 1 g/cm³ can still be achieved.

In addition to the components described above, the thermoplastic composite further comprises other auxiliaries used for improving various properties of the prepared thermoplastic composite. The auxiliaries include an inorganic filler used for improving mechanical properties of the material; a compatibilizer used for enhancing the compatibility between respective components in the composite; a toughener used for enhancing the toughness of the composite; a antioxidant used for improving antioxidant properties of the composite. Thus, the thermoplastic composite may further comprise one or more of an inorganic filler, a compatibilizer, a toughener, or an antioxidant.

Examples of suitable inorganic fillers include one or more selected from a glass fiber, a carbon fiber, a basalt fiber, talc, montmorillonite.

The compatibilizer may be selected from the compatibilizers in the art typically used for performing compatibilization on composites. In some embodiments, the compatibilizer is maleic anhydride grafted polypropylene. Commercially available compatibilizers include polypropylene grafted maleic anhydride from Shanghai Yuanyuan Polymer Co., Ltd.

The toughener may be selected from the tougheners in the art typically used for toughening composites. In some embodiments, the toughener comprise at least one of polyethylene and a polyolefin elastomer. Examples of useful tougheners include an ethylene propylene elastomer, an ethylene octene elastomer, an ethylene propylene diene elastomer, an ethylene propylene octene elastomer, polybutadiene, a butadiene copolymer, styrene/butadiene rubber (SBR), and block copolymers such as styrene-isoprene-styrene, styrene-butadiene-styrene, styrene-ethylene-butylene-styrene triblock or styrene-isoprene, styrene-butadiene, styrene-ethylene-butylene starblock polymers. Commercially available tougheners include polyethylene from Sinopec Limited, China and polyolefin elastomer from Dow Corporation.

The antioxidant is not particularly limited, and it may be selected from antioxidants in the art typically used for composites. In some embodiments, the antioxidant is one or more selected from pentaerythritol tetrakis 3-(3,5-di-tert-butyl-4-hydroxyphenyl) propionate and tris (2,4-di-tert-butyl) phosphite. Commercially available antioxidants include antioxidants available under the trade designations “IRGANOX 1010” (i.e., pentaerythritol tetrakis 3-(3,5-di-tert-butyl-4-hydroxyphenyl) propionate) from BASF Corporation and antioxidant “IRGAFOS 168” (i.e., tris-(2,4-di-tert-butyl) phosphite) from BASF Corporation.

According to some embodiments of the present disclosure the content of the inorganic filler is 0% to 15% by weight, 2% to 15% by weight, or 5% to 12% by weight, based on 100% by weight of the total weight of the thermoplastic composite. According to some embodiments of the present disclosure, the content of the compatibilizer is 5% to 20% by weight, 5% to 15% by weight, or 6% to 12% by weight, based on 100% by weight of the total weight of the thermoplastic composite. According to some embodiments of the present disclosure, the content of the toughener is 0% to 15% by weight, 0% to 8% by weight, or 2% to 8% by weight, based on 100% by weight of the total weight of the thermoplastic composite. According to some embodiments of the present disclosure, the content of the antioxidant is 0.1% to 0.5% by weight, 0.1% to 0.4% by weight, or 0.2% to 0.3% by weight, based on 100% by weight of the total weight of the thermoplastic composite.

According to the present disclosure, the thermoplastic composite is present in the form of a pellet with an aspect ratio of 2-5, wherein the non-cellulosic organic fiber extends in the length direction of the pellet and the non-cellulosic organic fiber has a length of 5 mm to 25 mm, 8 mm to 20 mm, or 10 mm to 12 mm.

### Method for Preparing Thermoplastic Composite

According to another aspect of the present disclosure there provides a method for preparing a thermoplastic composite, comprising the steps of:

(a) melt-mixing a thermoplastic resin and hollow glass microspheres to obtain a molten mixture; and

(b) mixing and impregnating non-cellulosic organic fiber with the molten mixture to obtain a thermoplastic composite containing the thermoplastic resin, the hollow glass microspheres, and the non-cellulosic organic fiber.

According to some embodiments of the present disclosure, it is possible in the step (a) that a thermoplastic resin and hollow glass microspheres are melt-mixed together with an auxiliary to obtain a molten mixture, wherein the auxiliary comprises one or more of an inorganic filler, a compatibilizer, a toughener, and an antioxidant; and in the step (b), the molten mixture and a non-cellulosic organic fiber are mixed and impregnated to obtain a thermoplastic composite containing the thermoplastic resin, the hollow glass microspheres, the auxiliary, and the non-cellulosic organic fiber.

According to some embodiments of the present disclosure, a step (c) of pulling the thermoplastic composite and cutting it into the form of pellets may be included after step (b).

According to some embodiments of the present disclosure, the step (a) is performed in a twin-screw extruder.

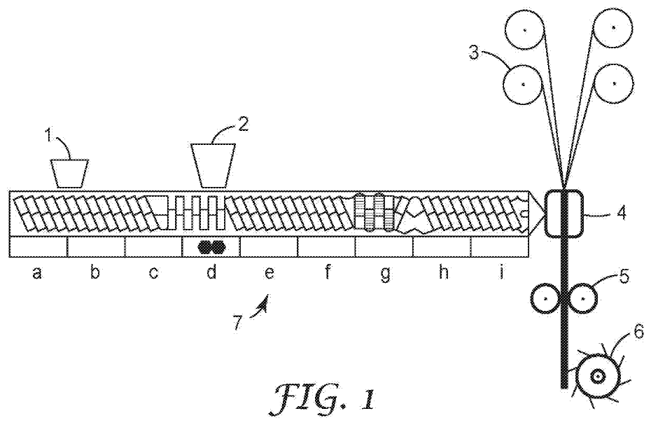

According to some embodiments of the present disclosure, a schematic method for preparing a thermoplastic composite according to the present disclosure will be specifically described below with reference to FIG. 1, wherein the mixing and extrusion of raw materials are performed in a twin-screw extruder 7, which comprises a first feeding hopper 1, a second feeding hopper 2, a plurality of areas a-i (including but not limited to areas a-i) at different temperatures, and a die 4.

The schematic method for preparing a thermoplastic composite according to the present disclosure shown in FIG. 1 comprise the steps of: preheating the twin-screw extruder 7 to a set temperature; adding a thermoplastic resin (as well as various auxiliaries) to the first feeding hopper 1 for mixing and preheating to obtain a pre-mixture; adding hollow glass microspheres to the second feeding hopper 2 to be melt-mixed with the pre-mixture so as to obtain a molten mixture; supplying a non-cellulosic organic fiber from one or more fiber supply rolls 3 to the die 4 while extruding the molten mixture into the die 4 to mix and impregnate the molten mixture and a non-cellulosic organic fiber so as to obtain an impregnated band containing the thermoplastic resin, the hollow glass microspheres, and a non-cellulosic organic fiber (as well as the auxiliaries); and cutting the impregnated band pulled from the die 4 into pellets with a desired size using a cutter 6. Alternatively, non-cellulosic organic fiber may be added into the twin screw extruder through a downstream port prior to the strand die.

### Injection-Molded Product

Another aspect of the present disclosure is an injection-molded product. A further aspect of the present disclosure is an injection-molded product which has been subjected to supercritical foaming injection molding.

### Method for Preparing Injection-Molded Product

According to some embodiments of the present disclosure, a conventional injection molding process in the prior art may be employed to perform injection molding on the thermoplastic composite provided by the present disclosure. For example, an MJ-20H plastic injection molder from Chen Hsong Machinery Co. Ltd, which comprises three heating areas, may be employed to perform injection molding on the thermoplastic composite provided by the present disclosure. According to some embodiments of the present disclosure, a supercritical foaming process may be further incorporated to perform supercritical foaming injection molding on the thermoplastic composite provided by the present disclosure.

The supercritical foaming process is a foaming technique for decreasing the density of injection-molded product articles. However, the use of this process will usually lead to reduction of mechanical properties of foamed articles. Often when making lightweight polypropylene composites using supercritical foaming processes the elongation at break and the notched impact strength of materials may be reduced. The inventor of the present application found that by using the thermoplastic composite provided by the present disclosure and introducing a supercritical foaming process into the injection molding process, the density of the thermoplastic composite may be further reduced while other mechanical properties of the material, particularly the elongation at break and the notched impact strength of the material, are substantially maintained.

According to some embodiments of the present disclosure, a supercritical carbon dioxide foaming process may be incorporated to perform injection molding on the thermoplastic composite provided by the present disclosure. For example, a Mucell®-enabled Engel ES200/100TL injection molder may be employed to perform supercritical foaming injection molding on the thermoplastic composite wherein this injection molder comprises three heating areas and comprises two injection nozzle areas at its injection port. For further details about microcellular thermoplastic resins including hollow glass microspheres, see, e.g., U.S. Pat. App. No. 2015/0102528 (Gunes et al.)

The following embodiments are intended to be illustrative of the present disclosure and not limiting.

In a first embodiment, the present disclosure provides a thermoplastic composite, comprising 35% to 85% by weight of a thermoplastic resin, 5% to 45% by weight of a non-cellulosic organic fiber, and hollow glass microspheres in an amount of less than 5% by weight, based on 100% by weight of the total weight of the thermoplastic composite.

In a second embodiment, the present disclosure provides the thermoplastic composite according to the first embodiment, wherein the thermoplastic resin comprises at least one of polypropylene, polyethylene, polyvinyl chloride, polystyrene, an ethylene-vinyl acetate copolymer, an acrylonitrile-styrene-butadiene copolymer, nylon 6, an ethylene propylene copolymer, an ethylene octene copolymer, an ethylene propylene diene copolymer, an ethylene propylene octene copolymer, polybutadiene, a butadiene copolymer, styrene/butadiene rubber (SBR), a block copolymer (e.g., styrene-isoprene-styrene or styrene-butadiene-styrene), or a styrene-ethylene-butylene-styrene triblock copolymer.

In a third embodiment, the present disclosure provides the thermoplastic composite according to the first or second embodiment, wherein the non-cellulosic organic fiber comprises at least one of a nylon 66 fiber, a polyethylene terephthalate fiber, a polypropylene terephthalate fiber, a polyphenylene sulfide fiber, a polyether ether ketone fiber, or an aramid fiber.

In a fourth embodiment, the present disclosure provides the thermoplastic composite according to any one of the first to third embodiments, wherein a higher melting peak of the non-cellulosic organic fiber is 60° C. or more higher than that of the thermoplastic resin.

In a fifth embodiment, the present disclosure provides the thermoplastic composite according to any one of the first to fourth embodiments, wherein the non-cellulosic organic fiber has a diameter of 5 μm to 70 μm.

In a sixth embodiment, the present disclosure provides the thermoplastic composite according to any one of the first to fifth embodiments, wherein the hollow glass microspheres have a particle diameter in a range from 5 μm to 100 μm, a density in a range from 0.3 g/cm³ to 0.8 g/cm³, and a compressive strength greater than 37.9 MPa.

In a seventh embodiment, the present disclosure provides the thermoplastic composite according to any one of the first to sixth embodiments, wherein the thermoplastic composite further comprises at least one of an inorganic filler, a compatibilizer, a toughener, or an antioxidant.

In an eighth embodiment, the present disclosure provides the thermoplastic composite according to the seventh embodiment, wherein the inorganic filler comprises at least one of a glass fiber, a carbon fiber, a basalt fiber, talc, or montmorillonite.

In a ninth embodiment, the present disclosure provides the thermoplastic composite according to any one of the first to eighth embodiments, wherein the thermoplastic composite is in the form of a pellet, wherein the non-cellulosic organic fiber extends in the length direction of the pellet, and wherein the non-cellulosic organic fiber has a length in a range from 5 mm to 25 mm.

In a tenth embodiment, the present disclosure provides the thermoplastic composite according to any one of the first to ninth embodiments, wherein the thermoplastic composite comprises 15% to 30% by weight of the non-cellulosic organic fiber and 0.5% to 4.5% by weight of the hollow glass microsphere, based on 100% by weight of the total weight of the thermoplastic composite.

In an eleventh embodiment, the present disclosure provides the thermoplastic composite according to any one of the first to ninth embodiments, wherein the thermoplastic composite comprises at least one of 0.5% to 4.5% by weight, 0.5% to 4% by weight, 1% to 4.5% by weight, 1% to 4% by weight, or 1% to 3% by weight of the hollow glass microspheres, based on 100% by weight of the total weight of the thermoplastic composite.

In a twelfth embodiment, the present disclosure provides a method for preparing the thermoplastic composite of any one of the first to eleventh embodiments, the method comprising:

melt-mixing a thermoplastic resin and hollow glass microspheres to obtain a molten mixture; and

mixing and impregnating non-cellulosic organic fiber with the molten mixture to obtain a thermoplastic composite containing the thermoplastic resin, the hollow glass microspheres, and the non-cellulosic organic fiber.

In a thirteenth embodiment, the present disclosure provides a method for preparing a thermoplastic composite, the method comprising:

melt-mixing a thermoplastic resin and hollow glass microspheres to obtain a molten mixture; and

mixing and impregnating non-cellulosic organic fiber with the molten mixture to obtain a thermoplastic composite containing the thermoplastic resin, the hollow glass microspheres, and the non-cellulosic organic fiber.

In a fourteenth embodiment, the present disclosure provides the method according to the thirteenth embodiment, wherein the thermoplastic resin comprises at least one of polypropylene, polyethylene, polyvinyl chloride, polystyrene, an ethylene-vinyl acetate copolymer, an acrylonitrile-styrene-butadiene copolymer, or nylon 6.

In a fifteenth embodiment, the present disclosure provides the method according to the thirteenth or fourteenth embodiment, wherein the non-cellulosic organic fiber comprises at least one of a nylon 66 fiber, a polyethylene terephthalate fiber, a polypropylene terephthalate fiber, a polyphenylene sulfide fiber, a polyether ether ketone fiber, or an aramid fiber.

In a sixteenth embodiment, the present disclosure provides the method according to any one of the thirteenth to fifteenth embodiments, wherein a higher melting peak of the non-cellulosic organic fiber is 60° C. or more higher than that of the thermoplastic resin.

In a seventeenth embodiment, the present disclosure provides the method according to any one of the thirteenth to sixteenth embodiments, wherein the non-cellulosic organic fiber has a diameter of 5 μm to 70 μm.

In an eighteenth embodiment, the present disclosure provides the method according to any one of the thirteenth to seventeenth embodiments, wherein the hollow glass microspheres have a particle diameter in a range from 5 μm to 100 μm, a density in a range from 0.3 g/cm³ to 0.8 g/cm³, and a compressive strength greater than 37.9 MPa.

In a nineteenth embodiment, the present disclosure provides the method according to any one of the twelfth to eighteenth embodiments, wherein the thermoplastic resin and hollow glass microspheres are melt-mixed together with an auxiliary to obtain a molten mixture, wherein the auxiliary comprises at least one of an inorganic filler, a compatibilizer, a toughener, and an antioxidant; and wherein the molten mixture and a non-cellulosic organic fiber are mixed and impregnated to obtain a thermoplastic composite containing the thermoplastic resin, the hollow glass microspheres, the auxiliary, and the non-cellulosic organic fiber.

In a twentieth embodiment, the present disclosure provides the method according to the nineteenth embodiment, wherein the inorganic filler comprises at least one of a glass fiber, a carbon fiber, a basalt fiber, talc, or montmorillonite.

In a twenty-first embodiment, the present disclosure provides the method according to any one of the twelfth to twentieth embodiments, wherein melt-mixing is performed in a twin-screw extruder.

In a twenty-second embodiment, the present disclosure provides the method according to any one of the twelfth to twenty-first embodiments, further comprising pulling the thermoplastic composite comprising the thermoplastic resin, the hollow glass microspheres, and the non-cellulosic organic fiber and cutting the thermoplastic composite into the form of pellets.

In a twenty-third embodiment, the present disclosure provides the method according to the twenty-second embodiment, wherein the non-cellulosic organic fiber has a length in a range from 5 mm to 25 mm.

In a twenty-fourth embodiment, the present disclosure provides the method according to any one of the thirteenth to twenty-third embodiments, wherein the thermoplastic composite comprises 15% to 30% by weight of the non-cellulosic organic fiber and 0.5% to 4.5% by weight of the hollow glass microsphere, based on 100% by weight of the total weight of the thermoplastic composite.

In twenty-fifth embodiment, the present disclosure provides the method according to any one of the thirteenth to twenty-fourth embodiments, wherein the thermoplastic composite comprises at least one of 0.5% to 4.5% by weight, 0.5% to 4% by weight, 1% to 4.5% by weight, 1% to 4% by weight, or 1% to 3% by weight of the hollow glass microspheres, based on 100% by weight of the total weight of the thermoplastic composite.

In a twenty-sixth embodiment, the present disclosure provides an injection-molded product comprising the thermoplastic composite according to any one of the first to eleventh embodiments, which has been subjected to injection molding.

In a twenty-seventh embodiment, the present disclosure provides the injection-molded product according to the twenty-fifth embodiment, which has been subjected to supercritical foaming injection molding.

In a twenty-eighth embodiment, the present disclosure provides the injection-molded product according of the twenty-seventh embodiment, wherein the supercritical foaming injection molding is supercritical carbon dioxide foaming injection molding.

### EXAMPLES

Examples are provided below, but it is to be emphasized that the scope of the present disclosure is not limited to the following examples. All parts and percentages are by weight, unless specified otherwise.

The raw materials that were employed in below described Examples are shown in Table 1.

TABLE 1

| Designation | Chemical Description | Function | Suppliers |
|---|---|---|---|
| PP K9026 | Polypropylene resin | Thermoplastic resin | Sinopec Limited, China |
| PP K2051 | Polypropylene resin | Thermoplastic resin | Formosa Plastics |
| | | | Corporation, Taiwan |
| PP 3920 | Polypropylene resin | Thermoplastic resin | SK Corporation, South |
| | | | Korea |
| PP 3015 | Polypropylene resin | Thermoplastic resin | Formosa Chemicals & |
| | | | Fibre Corporation, Taiwan |
| POE | Polyolefin elastomer having | Toughener | Shanghai Yuanyuan |
| | the Dow Chemical Company | | Polymer Co., Ltd., China |
| | trade designation “ENGAGE | | |
| | 8842” | | |
| LDPE-2003 | Low Density Polyethylene | Toughener | Sinopec Limited, China |
| | (LDPE) | | |
| PP-MAH | Polypropylene grafted maleic | Compatibilizer | Shanghai Yuanyuan |
| | anhydride obtained under the | | Polymer Co., Ltd. |
| | trade designation “E018T” | | |
| “IRGANOX | Pentaerithrytol Tetrakis | Antioxidant | BASF Corporation, |
| 1010” | 3-(3,5-di-tert-butyl-4-hydroxy | | Ludwigshafen, Germany |
| | phenyl) propionate obtained | | |
| | under the trade designation | | |
| | “IRGANOX 1010” | | |
| “IRGAFOS 168” | Tris (2,4-di-tert-butyl) | Antioxidant | BASF Corporation, |
| | phosphite obtained under the | | Ludwigshafen, Germany |
| | trade designation “IRGAFOS | | |
| | 168” | | |
| PA (NYLON) 66 | Nylon 66 polyamide fiber | Non-cellulosic | Invista Ltd., China |
| fiber | without surface modificaiton, | organic fiber | |
| | having an average diameter of | | |
| | 15-20 μm | | |
| LS 056 (PET) | Polyethyelene terepthalate | Non-cellulosic | Jiangsu Hengli Chemical |
| fiber | (PET) fiber with an average | organic fiber | Fibre Co., Ltd. |
| | diameter of 20 μm | | |
| “iM16K” | Hollow glass microspheres | Hollow glass | 3M Corporation, St. Paul, |
| | with an average diameter of 20 | microspheres | MN |
| | μm, and density of 0.46 g/cm3, | | |
| | and a compressive stength of | | |
| | 113.8 MPa | | |

### General Injection Molding Process

An MJ-20H Plastic Injection Molder from Chen Hsong Machinery Co. Ltd, China with three heating areas, was used to perform injection molding on the thermoplastic composites of Examples described below. The temperature of the injection nozzle was 200° C. The temperature of the first heating area was 200° C. The temperature of the second and third heating areas was 195° C. The temperature of the die was 40° C. The melting pressure was 5 Megapascals (MPa). The cooling time was 15 seconds.

Test specimens were molded using the injection molding machine to obtain ASTM Type I tensile test specimens (as described in ASTM D638-10: Standard Test Method for Tensile Properties of Plastics).

### Test Methods

Various property tests were performed on the injection-molded products to evaluate physical properties including flexural modulus, elongation at break, notched impact strength and density. The flexural modulus was evaluated according to ASTM D-790-15: Standard Test Method for Flexural Properties of Unreinforced and Reinforced Plastics and Electrical Insulating Materials, the elongation at break was evaluated according to ASTM D638-10: Standard Test Method for Tensile Properties of Plastics, and the notched impact strength was evaluated according to ASTM D-256-10e1: Standard Test Methods for Determining the Izod Pendulum Impact Resistance of Plastics. Specifically, a standard injection-molded sample bar per each ASTM with a thickness of 3.2 mm was placed in an environment at a temperature of 20° C. and a relative humidity of 50% for 48 hours. Then for the flexural modulus and elongation at break the tests were performed on an IINSTRON 5969 (Norwood, Mass.) universal testing machine. The notched impact test was performed on a Model PIT550A-2 Pendulum Impact Testing machine (Shenzhen Wance Testing Machine Co., Ltd.) with an impact hammer of 2.75 J.

The density of the injection-molded product, with a unit of g/cm³, was obtained by dividing the weight of the resultant injection-molded product by the volume according to ASTM D792 using a METTLER TOLEDO A1204 density balance (Toledo, Ohio).

### Example 1 (Ex. 1)

“iM16K” hollow glass microspheres and PA (Nylon) 66 fiber were both dried at 120° C. for 2 hours before use.

32 parts by weight of PP K9026, 35 parts by weight of PP 3015, 25 parts by weight of PP 3920, and 8 parts by weight of PP K2051 were mixed in barrel at 20° C. to obtain a thermoplastic resin blend referred to as “PP Blend 1”.

A twin-screw extruder (TDM20) made by Guangzhou POTOP Co. Ltd as shown in FIG. 1 was preheated to set temperatures, wherein the set temperatures of respective areas (areas a-i) from the first feeding hopper to the die were respectively: 150° C., 210° C., 215° C., 210° C., 210° C., 210° C., 205° C., 205° C., and 205° C., in this order.

67 parts by weight of the “PP Blend 1” and 2 parts by weight of POE, 3 parts by weight of low density polyethylene, 7 parts by weight of PP-MAH and 0.3 parts by weight of an antioxidant (wherein the weight ratio of antioxidant “IRGANOX 1010” to antioxidant “IRGAFOS 168” in the antioxidant was 3:1) were added to the first feeding hopper for mixing to obtain a pre-mixture.

1 part by weight of “iM16K” hollow glass microspheres were added to the second feeding hopper.

The twin-screw extruder was started to allow the melt mixing of 1 part by weight of “iM16K” hollow glass microspheres and 70.3 parts by weight of the pre-mixture at 200° C. so that a molten mixture was obtained.

20 parts by weight of PA (Nylon) 66 fiber, in the form of a bundle, were supplied from a fiber supply roll to a die at a temperature of 205° C., while 80.3 parts by weight of the molten mixture were extruded into the die so as to obtain a composite fiber. The composite was pulled to a cutter at a rate of 1.5 m/min and was cut into pellets with a length of 10-12 mm and dried.

The Example 1 pellets had the composition shown in Table 2. The Example 1 pellets were made into test sample bars according to the “General Injection Molding Process” and the test sample bars were tested according to the “Test Methods” The test results are shown in Table 4.

### Example 2 (Ex. 2)

Example 2 samples were prepared in the same manner as Example 1 except that the amount of “iM16K” was increased to 3 parts instead of 1 part and the amount of “PP Blend 1” was reduced to 65 parts from 67 parts.

The Example 2 pellets had the composition shown in Table 2. The Example 2 pellets were made into test sample bars according to the “General Injection Molding Process” and the test sample bars were tested according to the “Test Methods” The test results are shown in Table 4.

TABLE 2

| | Ingredient | | | | | | | | | |
|---|---|---|---|---|---|---|---|---|---|---|
| | PP | PP | PP | PP | | | PP- | | PA 66 | Antioxidant |
| Example | K9026 | 3920 | 3015 | K2051 | LDPE | “iM16K” | MAH | POE | Fiber | “1010”/“168” |
| Ex. 1 | 21.4 | 16.7 | 23.5 | 5.4 | 3 | 1 | 7 | 2 | 20 | 0.3/0.1 |
| Ex. 2 | 20.8 | 16.25 | 22.75 | 5.2 | 3 | 3 | 7 | 2 | 20 | 0.3/0.1 |

### Example 3 (Ex. 3)

Example 3 samples were prepared in the same manner as Example 1 except that the PA Nylon 66 fiber was replaced with an equal amount of PET fiber.

The Example 3 pellets had the composition shown in Table 3. The Example 3 pellets were made into test sample bars according to the “General Injection Molding Process” and the test sample bars were tested according to the “Test Methods” The test results are shown in Table 4.

### Example 4 (Ex. 4)

Example 4 samples were prepared in the same manner as Example 2 except that the PA Nylon 66 fiber was replaced with an equal amount of PET fiber.

The Example 4 pellets had the composition shown in Table 3. The Example 4 pellets were made into test sample bars according to the “General Injection Molding Process” and the test sample bars were tested according to the “Test Methods” The test results are shown in Table 4.

TABLE 3

| | Ingredient | | | | | | | | | |
|---|---|---|---|---|---|---|---|---|---|---|
| | PP | PP | PP | PP | | | | | PET | Antioxidant |
| Example | K9026 | 3920 | 3015 | K2051 | LDPE | “iM16K” | PP-MAH | POE | Fiber | “1010”/“168” |
| Ex. 3 | 21.4 | 16.7 | 23.5 | 5.4 | 3 | 1 | 7 | 2 | 20 | 0.3/0.1 |
| Ex. 4 4 | 20.8 | 16.25 | 22.75 | 5.2 | 3 | 3 | 7 | 2 | 20 | 0.3/0.1 |

The above prepared Example 1-4 samples were tested using the methods described above. The test results are summarized in Table 4, below.

TABLE 4

| | Flexural | Elongation | | |
|---|---|---|---|---|
| | modulus | at break | Notched impact | Density |
| | (MPa) | (%) | strength (KJ/m²) | (g/cm³) |
| Example 1 | 1760 | 25.7 | 57.6 | 0.946 |
| Example 2 | 1820 | 23.4 | 54.7 | 0.932 |
| Example 3 | 1750 | 28.9 | 63.9 | 0.985 |
| Example 4 | 1850 | 26.5 | 55.5 | 0.973 |

It should be understood by the person skilled in the art that various modifications and variations can be made without departing from the scope of the present disclosure. Such modifications and variations are intended to fall in the scope of the present disclosure defined by the following appended claims.

1. A thermoplastic composite comprising 35% to 85% by weight thermoplastic resin, 5% to 45% by weight of a non-cellulosic organic fiber, and hollow glass microspheres in an amount of less than 5% by weight, based on 100% by weight of the total weight of the thermoplastic composite.

2. The thermoplastic composite according to claim 1, wherein the thermoplastic resin comprises at least one of polypropylene, polyethylene, polyvinyl chloride, polystyrene, an ethylene-vinyl acetate copolymer, an acrylonitrile-styrene-butadiene copolymer, nylon 6, an ethylene propylene copolymer, an ethylene octene copolymer, an ethylene propylene diene copolymer, an ethylene propylene octene copolymer, polybutadiene, a butadiene copolymer, styrene/butadiene rubber (SBR), a styrene-isoprene-styrene copolymer, styrene-butadiene-styrene copolymer, or a styrene-ethylene-butylene-styrene triblock copolymer.

3. The thermoplastic composite according to claim 1, wherein the non-cellulosic organic fiber comprises at least one of a nylon 66 fiber, a polyethylene terephthalate fiber, a polypropylene terephthalate fiber, a polyphenylene sulfide fiber, a polyether ether ketone fiber, or an aramid fiber.

4. The thermoplastic composite according to claim 1, wherein a higher melting peak of the non-cellulosic organic fiber is 60° C. or more higher than that of the thermoplastic resin.

5. The thermoplastic composite according to claim 1, wherein the non-cellulosic organic fiber has a diameter of 5 μm to 70 μm.

6. The thermoplastic composite according to claim 1, wherein the hollow glass microspheres have a particle diameter of in a range from 5 μm to 100 μm, a density in a range from 0.3 g/cm³ to 0.8 g/cm³, and a compressive strength greater than 37.9 MPa.

7. The thermoplastic composite according to claim 1, wherein the thermoplastic composite further comprises at least one of an inorganic filler, a compatibilizer, a toughener, or an antioxidant.

8. The thermoplastic composite according to claim 7, wherein the inorganic filler selected comprises at least one of a glass fiber, a carbon fiber, a basalt fiber, talc, or montmorillonite.

9. The thermoplastic composite according to claim 1, wherein the thermoplastic composite is in the form of a pellet, wherein the non-cellulosic organic fiber extends in the length direction of the pellet, and wherein the non-cellulosic organic fiber has a length in a range from 5 mm to 25 mm.

10. The thermoplastic composite according to claim 1, wherein the thermoplastic composite comprises 0.5% to 4.5% by weight of the hollow glass microsphere, based on 100% by weight of the total weight of the thermoplastic composite.

11. A method for preparing the thermoplastic composite according to claim 1, the method comprising:
melt-mixing the thermoplastic resin and the hollow glass microspheres to obtain a molten mixture; and
mixing and impregnating the non-cellulosic organic fiber with the molten mixture to obtain a thermoplastic composite containing the thermoplastic resin, the hollow glass microspheres, and the non-cellulosic organic fiber.

12. The method for preparing the thermoplastic composite according to claim 11, wherein the thermoplastic resin and the hollow glass microspheres are melt-mixed together with an auxiliary to obtain a molten mixture, wherein the auxiliary comprises at least one of an inorganic filler, a compatibilizer, a toughener, and an antioxidant, and wherein the molten mixture and the non-cellulosic organic fiber are mixed and impregnated to obtain a thermoplastic composite containing the thermoplastic resin, the hollow glass microspheres, the auxiliary, and the non-cellulosic organic fiber.

13. The method for preparing the thermoplastic composite according to claim 11, wherein the melt-mixing is performed in a twin-screw extruder.

14. An injection-molded product, comprising the thermoplastic composite according to claim 1, which has been subjected to injection molding.

15. The injection-molded product according to claim 14, which has been subjected to supercritical foaming injection molding.

16. The method according to claim 11, wherein the thermoplastic composite comprises 0.5% to 4.5% by weight of the hollow glass microsphere, based on 100% by weight of the total weight of the thermoplastic composite.

17. The method according to claim 11, further comprising pulling the thermoplastic composite comprising the thermoplastic resin, the hollow glass microspheres, and the non-cellulosic organic fiber and cutting the thermoplastic composite into the form of pellets.

18. The method according to claim 11, wherein the thermoplastic resin comprises at least one of polypropylene, polyethylene, polyvinyl chloride, polystyrene, an ethylene-vinyl acetate copolymer, an acrylonitrile-styrene-butadiene copolymer, nylon 6, an ethylene propylene copolymer, an ethylene octene copolymer, an ethylene propylene diene copolymer, an ethylene propylene octene copolymer, polybutadiene, a butadiene copolymer, styrene/butadiene rubber (SBR), a styrene-isoprene-styrene copolymer, styrene-butadiene-styrene copolymer, or a styrene-ethylene-butylene-styrene triblock copolymer.

19. The method according to claim 11, wherein the non-cellulosic organic fiber comprises at least one of a nylon 66 fiber, a polyethylene terephthalate fiber, a polypropylene terephthalate fiber, a polyphenylene sulfide fiber, a polyether ether ketone fiber, or an aramid fiber.

20. The method according to claim 11, wherein the non-cellulosic organic fiber has a diameter of 5 μm to 70 μm.
